(19) United States
(12) Patent Application Publication
(10) Pub. No.: US 2011/0123878 A1
(43) Pub. Date: May 26, 2011

(54) Dual Purpose Gas Purification by Using Pressure Swing Adsorption Columns for Chromatographic Gas Separation

(76) Inventor: Juzer Jangbarwala, Chino Hills, CA (US)

(21) Appl. No.: 12/953,116

(22) Filed: Nov. 23, 2010

Related U.S. Application Data
(60) Provisional application No. 61/263,993, filed on Nov. 24, 2009.

(51) Int. Cl. B01D 53/047; B01D 53/02; H01M 8/06; F02B 43/08

(52) U.S. Cl. 429/410; 95/96; 95/82; 123/3

(57) ABSTRACT

A pressure swing adsorption process wherein a gas mixture comprised of a reformate gas and a biomass gas is processed to remove contaminants.

### Field of the Invention

The present invention relates to a pressure swing adsorption process wherein a gas mixture comprised of a reformate gas and a biomass gas is processed to remove contaminants.

### BACKGROUND OF THE INVENTION

Pressure Swing Adsorption (PSA) is a known industrial process used to separate gases with different molecular weights. The process and its art have been practiced for hydrogen purification, nitrogen and oxygen separation from air, and other specialty gas separations such as CO₂ and CO, etc.

The process is primarily driven by molecular sieves such as activated carbon, activated alumina, and other zeolites acting as adsorption media for gases under pressure. As gases approach their dew points, adsorption characteristics are pronounced, and if the gases to be separated have very different dew points, they exhibit very sharp separation on particular adsorbents.

PSA systems are manufactured with slight variances, but primarily consist of the following steps in operation:

1) Adsorption stage (service): In this stage, the least adsorbed gas is recovered from the mixed gas stream with high purity. Feed gas is typically fed from the bottom of the adsorbent column and high purity gas exits the top.

2) Upon “exhaustion”, determined either by a timed cycle (in consistent feed streams, such as air) or a gas analysis sensor of some sort, the bed is regenerated. Feed flow is typically diverted to a standby column. The first stage of the regeneration consists of “co-current” and staged depressurization of the column. Using multiple stages to de-pressurize the column allows the removal of any purified gas to be collected for high recovery. If the column is depressurized rapidly, the gas stream does not get enough time to diffuse out of the “void” spaces and gets contaminated by the rapid “desorption” of the (undesired) adsorbed components.

3) The staged depressurization is typically stopped at a pressure midway between service and atmospheric. The bed is then depressurize “counter-current” to service flow by simply venting to an atmospheric outlet which may include a “flare” to burn the residual gas, if flammable.

4) After the column is at atmospheric pressure, it is “purged” at low pressure, in counter current mode with the desired high purity gas. The gas for this step is typically taken from the service outlet of the current working adsorbent bed with the pressure regulated down.

5) After the purge cycle, the bed is then re-pressurized, using the service gas flow of the purified gas, and then put on standby.

While the above system has been modified in many ways to increase efficiency for a single gas stream purification, such as simulated dynamic bed, and moving beds, there remains a need in industry to utilize a single PSA system for purification of two simultaneous feed streams.

In the rapidly evolving field of renewable energy, electricity generation from biogas is seen as a major potential source. Major sources of biogas are landfill gas anaerobic digester gas generated from bacterial decomposition of organic matter such as sludge from a wastewater treatment plant, wastewater from a food processing facility, palm oil mill effluents, wastewater from animal farms such as dairy, poultry, cattle and pig farms, etc.

Biogas from these sources has typically been fed directly to internal combustion engines (ICEs). These engines convert about 30% of the energy of the biogas to electricity, and the rest to waste heat. These engines are modified slightly to operate on low methane content fuels, such as landfill gas and biogas. Such fuels can have BTU values as low as 450 BTUs per standard cubic foot compared to 930-1100 in pipeline natural gas. Examples of such engines are Guascor SFGLD series, Caterpillar G3520, Jenbacher J-312, etc. For various reasons, these engines cannot be run at very high air to gas ratios (very lean mixtures), required for low NOx emissions, and therefore create significant levels of Nitrogen Oxides (NOx), considered to be >300 times more potent as green house gases than CO₂. This creates a dilemma for renewable energy generators, and more so for the air quality permitting agencies. On the one hand, it is extremely beneficial to substitute fossil fuel energy with waste methane, and on the other, the combustion process deployed creates very toxic emissions. The industry therefore is employing a variety of methods to lower the NOx emissions, mainly due to the stringent air quality standards being proposed.

Of the several options available to industry, one of the simpler ones is to substitute ICEs with fuel cells. Another simple option is to generate hydrogen in situ and inject it into the ICE to allow much “leaner” air mixtures. Yet another option is to convert the ICE to a 100% hydrogen fueled engine. All these options require efficient hydrogen production in situ. Methane Steam Reforming (MSR) is the dominant production process for hydrogen worldwide. Since methane is the major component of biogas, hydrogen generation on site is a viable path for greener energy. Catalytic methane cracking is another process deployed for generation of green, zero carbon footprint hydrogen.

In the production of hydrogen from biogas, two separate gas purification steps are required. First, the biogas must be purified to give >90% methane with no sulfur or siloxane compounds to avoid poisoning of the reforming catalyst. Xebec Corporation, Linde Gases, Adsorptech and many companies make commercially available systems for this application. Second, the product of steam reforming, called the “reformate” must be purified to yield >99.99% hydrogen for feed into the fuel cell, or ICE as mentioned earlier. Questair, PDC Machines, Linde, Air Products, UOP and many other manufacturers market a commercial product for this application. The most common process used for both these separations is Pressure Swing Adsorption (PSA).

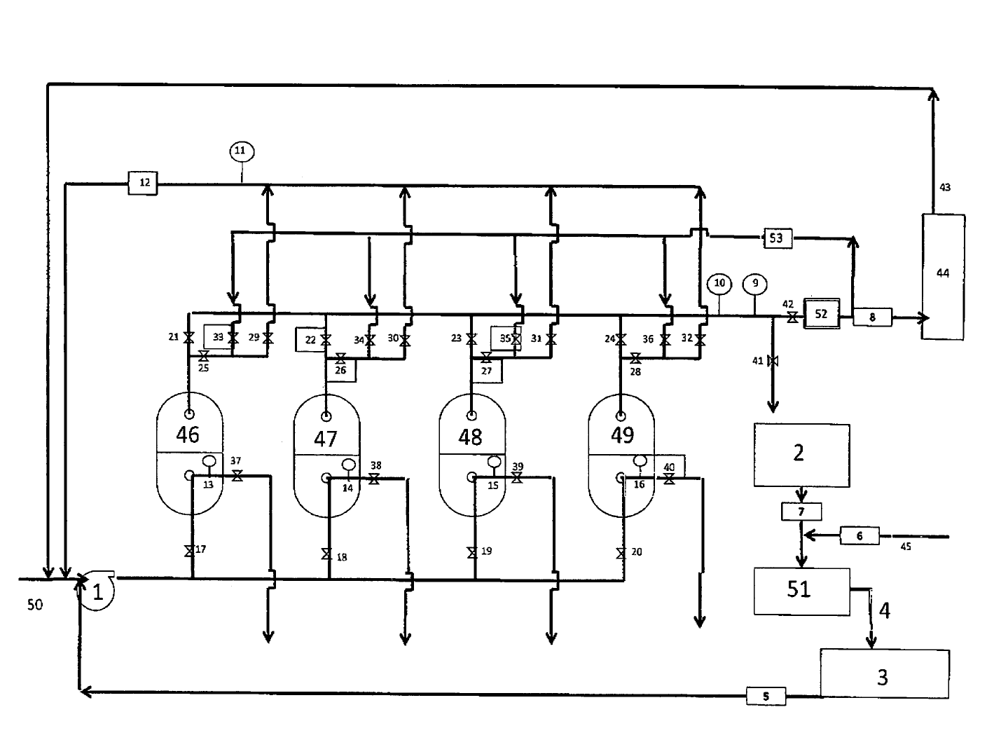

It is an object of this invention to combine the two PSA systems into a single unit in fluid communication with the hydrogen generation system. This single unit would utilize the appropriate molecular sieves for the two gas separations, which would be obvious to one skilled in the art. Details of such a system are described below with reference to FIG. 1.

PSAs typically have short service cycle times, and more than two adsorbent beds are used. Accordingly, FIG. 1 shows a set of 4 adsorbent beds as the operating structure of the PSA. The number of beds is not limited and depends on the gas composition, level of purity desired, cycle times desired, etc.

Referring to FIG. 1: Complete cycle of one bed 46 will be explained to the point of service switching to second bed 47 when 46 is exhausted. It should be clear to those skilled in the art that similar sequence is followed for beds 47-48, 48-49, and 49-46. It should also be clear to those skilled in the art that appropriate adsorbents and molecular sieves can be used either as the sole adsorbent or in layers to facilitate the separation.

Compressor 1 takes biogas 50 typically at low pressures (5-10 psig) and pressurizes it to operation pressure. Operation pressure can vary based on feed gas analysis from 3 atmospheres to 25 atmospheres. The gas is fed under pressure to 46 in an upflow direction. The adsorbent bed will establish a layered adsorption profile. It will adsorb the strongly adsorbed contaminants first, and such contaminants will occupy the bottom layer of the bed. The bed will also adsorb methane, which will form the next layer above the strongly adsorbed compounds. The bed will adsorb very little hydrogen, as is typical in hydrogen purification PSA systems. The hydrogen will be the initial stream of product gas and will be subjected to specific gas analyzers 9, 10. The analyzers will continuously monitor the purity of the hydrogen and methane. The purified hydrogen will be sent through valve 42 into an equalization tank 52 having a volume sufficient to be able to continuously supply hydrogen to the intended use device, 44, when the product gas is producing methane and such methane is being collected in storage tank 2. Hydrogen will be passed through a pressure regulator 8 to 44. 44 could be a fuel cell, and ICE or a collection tank for hydrogen. 8 will be a pressure regulator, which will reduce the operating pressure of the hydrogen to 5-50 psig. When sensors 9,10 confirm the presence of a predetermined % of methane, valve 42 will close and valve 41 will be opened to store the operating pressure methane in tank 2. The methane will be passed through pressure regulator 7 to maintain pressure required for the reforming system 51. The regulated pressure methane stream from storage tank 2 will be mixed by steam 45 equal to the volume desired by the reformer, and passed through pressure regulator 6. Pressure regulators 6 and 7 will be set at the same pressure. Reformate gas 4 from reformer 51 will be sent to condenser 3 where excess steam from the reaction will be condensed. Dry hydrogen gas 5 will be sent to a point on the biogas line 50, upstream of the compressor 1.

Similarly, any excess hydrogen in the case of ICEs or anode off gas (unused hydrogen) in the case of fuel cell from 44, shown as 43, will be sent to a point upstream of compressor 1. When sensors 9,10 indicate the presence of a predetermined volume of the undesired contaminant gas, bed 46 will be taken off line by turning valves 17 and 21 off, and bed 47 will be put on line by opening valve 18 and 22, and the sequence of hydrogen and methane collection as discussed for bed 46 will continue.

Regeneration of bed 46. As a first step, valve 25 will be opened. Next, the pressure in the vessel will be reduced to 40-50% of service pressure by sequential steps. Pressure Transmitter 11 will control the open and close timing of valve 29 multiple times, such as to achieve a 5 psig drop in pressure in each step. The purpose of this step is to remove any methane trapped in the void space between the adsorbent media granules. The gas will be connected via a vacuum breaker 12 to a point upstream of compressor 1.

Once a drop in pressure of 40-50% of operating pressure is reached, valve 29 will be closed and valve 37 will be opened to achieve atmospheric pressure in a controlled, staged method, by a feedback loop from pressure transmitter 13. The exhaust will be atmospheric pressure and will contain the undesired contaminants. This gas stream will be directed to a flare or other method of responsible disposal.

Next, while valve 37 is open, the bed will be purged with hydrogen from storage tank 52, with flow control 53. Sufficient hydrogen will be sent to 46 to purge any residual contaminants from the bed, and then valve 37 will be closed. The system will pressurize with hydrogen, equilibrating with the pressure in the hydrogen storage tank 52. Bed 46 will now be ready for the next cycle.

What is claimed is:

1) A single PSA, which can be used to simultaneously purify biogas and product from a hydrogen generation system such as a steam methane reformer or catalytic methane cracking.

2) According to claim 1 in which the media used in the PSA for adsorption is defined as graphitic platelet nanofibers.

3) According to claim 1 in which the PSA performs a chromatographic separation of methane and hydrogen during the combined purification cycle.

4) According to claim 1 where gas analyzers on the product stream divert the methane and hydrogen to respective storage tanks to allow continuous operation.

5) According to claim 1 where reformate from a steam reformer or catalytic methane cracker is mixed with biogas to be subjected to the purification.

6) An integrated fuel cell system with the ability to take raw digester, landfill or other biogas an internally purify, reform and produce electricity.

7) An integrated ICE system with the ability to take raw digester, landfill or other biogas an internally purify, reform and produce electricity.
